(19) United States
(12) Patent Application Publication
(10) Pub. No.: US 2005/0119010 A1
(43) Pub. Date: Jun. 2, 2005

(54) Traffic information providing method and system therefor, and payment method for toll road fee

(76) Inventor: Daisuke Yasukawa, Hitachinaka (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/952,450

(22) Filed: Sep. 29, 2004

(30) Foreign Application Priority Data
Sep. 30, 2003 (JP) 2003-339036

(51) Int. Cl. H04L 12/66; H04M 11/00; H04Q 7/20

(52) U.S. Cl. 455/456.3; 455/407

(57) ABSTRACT

A traffic-information providing method includes steps of accepting registration from a terminal to a center concerning ID information for identifying a vehicle, billing both information associated with the ID information and information about a travel route along which the vehicle is scheduled to drive and which includes a toll road, calculating, at the center, future traffic information based on the travel route registered into the center, and providing the calculated future traffic information via a communications line. The traffic amount is predicted based on the travel route which the user has registered. It then becomes possible to provide the fine-grained traffic information.

### BACKGROUND OF THE INVENTION

1. Field of the Invention

The present invention relates to a road traffic-information service. More particularly, it relates to in-advance registration of a travel route and fee reduction using an electronic toll collection system.

2. Description of the Related Art

In the case of road situations offered in real time, e.g., wide-range traffic-information service via media such as television and radio and limited-area-oriented traffic-information service referred to as “VICS (: Vehicle Information and Communication System), as an area whose traffic information a user wishes to know is at a longer distance, and also as the traffic information acquired dates back to the past more, the traffic information proves to be more useless. Also, even if the user has acquired the most up-to-date information again in the area whose traffic information the user wishes to know, this information allows the user only to know the road situation where the user himself or herself is positioned at present. This, for example, means that, even if the user has recognized a traffic-congestion situation within the very traffic-congestion situation, this recognition gives none of the effective solving methods. Moreover, traffic-congestion predictions on long-term holidays such as golden week and summer vacation are predictions based on past statistical real-accomplishments. Accordingly, the predictions on traffic amount result in more or less abstract expressions such as “very large” and “small”, thereby imposing a limitation on the offering of accurate traffic information. In view of this situation, the following technology has been known in, e.g., JP-A-09-081894 and the like: Namely, when making a driving plan one week later, this technology allows the anticipation of a realistic transit necessary-time to which traffic-jam information up to the destination has been added.

### SUMMARY OF THE INVENTION

In the technology disclosed in the above-described publication, however, it is made possible only to calculate the traveling time by predicting the traffic congestion or the like from the past experiences. Here, this calculation based on the past experiences alone can be considered unreliable. Also, even if it has been found successful to calculate the traveling time, this success results in none of savings in money and time for the user.

It is an object of the present invention to provide a method for utilizing a more effective road traffic-information service.

The above-described object of the present invention can be accomplished by a procedure that the user makes in-advance registration of a travel route on a toll road, and that the traffic amount is predicted based on this registration contents.

It is possible to predict the traffic amount on which the driving schedule of the user has been reflected.

### BRIEF DESCRIPTION OF THE DRAWINGS

FIG. 1 is a diagram for illustrating an embodiment concerning a main screen flow;

FIG. 2 is a diagram for illustrating an embodiment regarding a travel route registration flow and an inquiry screen flow;

FIG. 3 is a diagram for illustrating an embodiment concerning a traffic-amount prediction screen flow;

FIG. 4 is a diagram for illustrating an embodiment regarding the travel route registration flow of a user;

FIG. 5 is a diagram for explaining system users and exchange of information;

FIG. 6 is a diagram for illustrating an embodiment concerning a flow for a road enterpriser to perform a bill processing to the user;

FIG. 7 is a lane-diagram example for illustrating an embodiment;

FIG. 8 is an in-advance registration situation example for illustrating an embodiment;

FIG. 9 is an example for illustrating the in-advance registration situation on time basis for illustrating an embodiment;

FIG. 10 is a diagram for illustrating an embodiment regarding the information usage flow of a road information utilizer; and

FIG. 11 is an example for illustrating the in-advance registration situation on fragmented-time basis for illustrating an embodiment.

### DESCRIPTION OF THE INVENTION

According to “Traffic Demand Estimation Investigation Materials” summarized by Road Bureau of Ministry of Land, Infrastructure and Transport, it is said that “In the sixth year of Heisei, checking the occurrence traffic amount on each time-zone basis indicates that, during rush hours in the morning and evening, the traffic amount for go-to-work/come-home purposes occupies most of the whole traffic. Also, during time zone of the daytime, the traffic amount for business purpose occupies most of the whole traffic.” As the type differentiation, the whole traffic is classified into go-to-work/go-to-school, business, come-home, and private purposes. It can be safely assumed that the traffic amount for private purpose is constant at substantially 20% from around 7 o'clock in the morning to 7 o'clock in the evening, and is equal to 0% in the other time zone. Here, assume that this tendency has not changed so significantly in recent years as well after a lapse of considerable time. Then, it can be considered that requesting the user to make the in-advance registration of the travel route makes it possible to accurately predict the route and the traffic amount by the amounts registered in this way. This is because the commuting route can be considered to be fixed since the home and the work office remain almost unchanged, and because the traffic amount for business purpose can also be considered to be substantially fixed. The traffic amount for the other purpose, i.e., the traffic amount for private purpose, can be considered as being an error, i.e., a statistically unfixed factor.

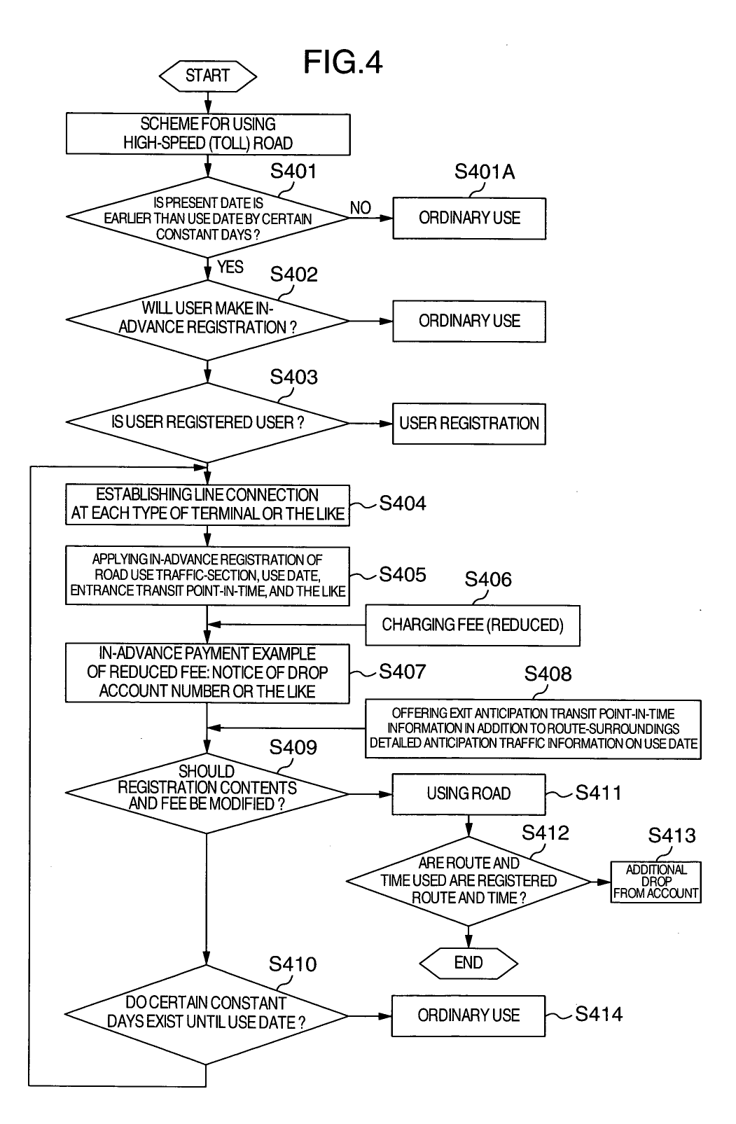

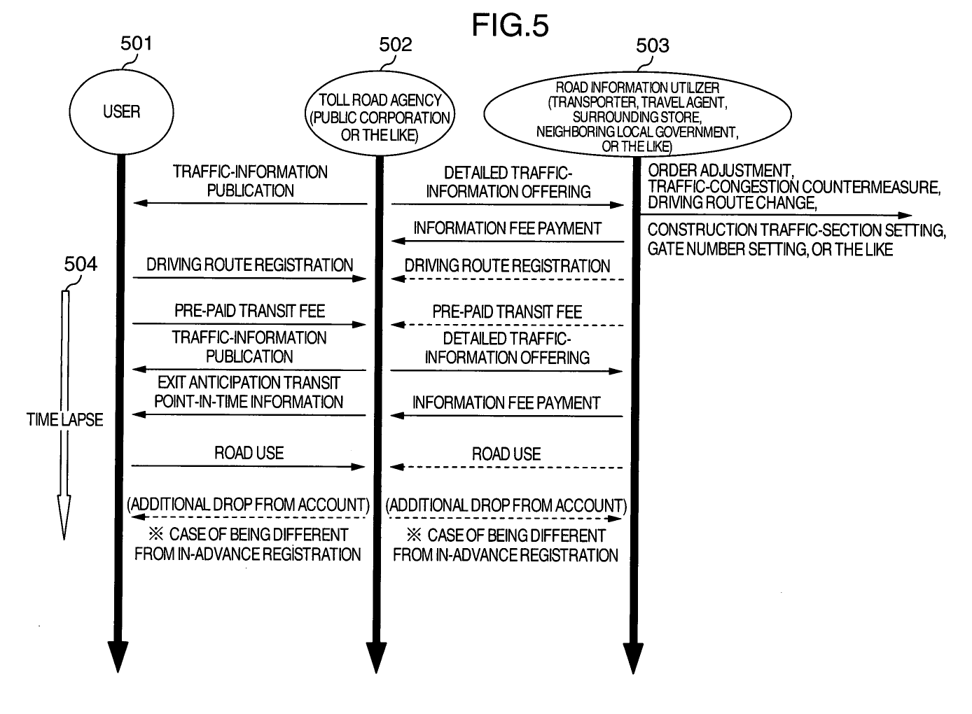

Next, referring to the drawings, the explanation will be given below concerning an embodiment which makes effective utilization of contents of the above-described consideration. Parties which play main roles in the embodiment are illustrated in FIG. 5, i.e., a general user 501, a road enterpriser 502 such as a public corporation, and a road information utilizer 503 such as a transporter. This embodiment will be explained below along time lapse 504. First, the road enterpriser 502 or tall road agency is always recruiting and accepting the in-advance registration of travel routes, and summarizes the travel route information accepted, and also publicizes the most up-to-date situation thereof. On a free-of-charge basis, whatever party is capable of thinking about its own travel route while watching this traffic information publicized, and is capable of making the reservation if it considers the reservation necessary. Here, representatives of parties which register their own travel routes are the user 501, i.e., a personal road user, and the road information utilizer 503, i.e., a party which wishes to acquire detailed traffic information and to utilize this information for its enterprises. A concrete example of the road information utilizer 503 includes a party such as a transporter or a travel agent which permanently uses the road as a so-called organization, a store such as a restaurant existing in the surroundings of the road, or a local government existing in the neighborhood of the road. It does not matter whether the permanent use of the road is on regular or irregular basis.

Here, FIG. 4 illustrates an embodiment of the travel route registration flow of a user. In this flow, the downward-direction arrow of a judgment block represents “yes”, and the rightward-direction arrow thereof represents “no” (this definition, hereinafter, will be the same in the other drawings as well). Schematically speaking, there exist the following steps: Namely, first, the user registration is made. Next, the registration of a travel route or the like is made. This step, then, is accompanied by the fee payment and the reception/utilization of information in response to this registration.

First of all, at a step S401, it is confirmed whether or not the present date is earlier than a use date by the time-interval of certain constant days. This means that the present date is, e.g., two weeks or one month before the use date. In the case of “yes”, the present system is usable which offers in-advance reduction and the like. In view of the characteristic of the present invention that traffic information in the future is predicted, in the case of “no”, i.e., the case where the user has tried to make the registration into the present system immediately before the use date, the information is of little practical value. Accordingly, it is determined that the present system is unusable in this case (S401A). Next, at a step S402, intention expression by the user is confirmed with respect to the in-advance registration. At a step S403, it is confirmed whether or not the user who has given the intention expression of the in-advance registration is an already registered user. This confirmation includes an implication of the identification confirmation for offering services such as the reduction in road fee. Here, in the case of “no”, this step is programmed to proceed to a user registration screen so as to prompt the user registration. This is performed in order that a large number of registrants will be ensured to enhance accuracy of the traffic-information prediction. Although the ID and password may be requested in the first place, it can be considered that requesting them halfway will make a contribution to an increase in the registrants.

After that, at a step S404, line connection is established, and, at a step S405, an in-advance registration application is filed for information necessary for the route registration. In response thereto, at a step S406, the reduced fee and the like are charged. Next, at a step S407, in-advance payment is performed by notifying drop account number, credit card number, or the like. With this step completed, unless a significant change has occurred to the traffic information, the user is allowed to use the road without necessitating whatever procedures until the very road use date and while receiving the offering of respective types of information (S408). When the user wishes to modify the route and the corresponding fee, e.g., a case where the traffic information has changed and where an extraordinary traffic congestion is expected to have occurred on the registered route, modifying the registered route and the corresponding fee is accepted (S409). In this way, it is a user's merit to modify the route or cancel the route use as a result of acquiring the detailed anticipation traffic information. Here, as having been judged at the first step, it is confirmed once again whether or not certain constant days exist until the use date (S410). Then, if none of the constant days exist, the user continues the use in accordance with the already registered contents (S414).

Meanwhile, if the user has used the registered route (S411), it is confirmed whether or not the registered route has been used properly, i.e., the route and time used have been the registered route and time (S412). If there occurs a difference amount compared with the amount paid at the in-advance payment, this difference amount is billed (S413), thereby terminating the series of processing steps.

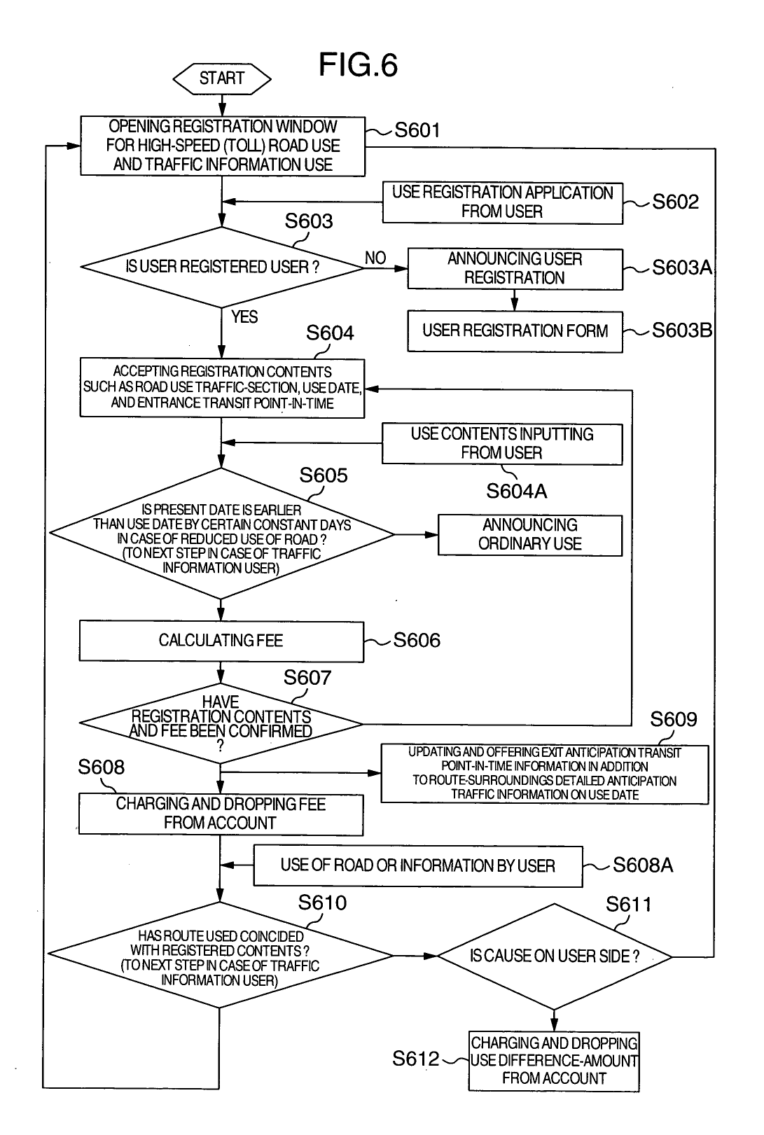

FIG. 6 illustrates a flow embodiment in the case where the road enterpriser 502 performs the bill processing to the user 501. Schematically speaking, there exist the following steps: Namely, first, the user registration is accepted. Next, there exist the registration of a travel route or the like, processing and offering of information in response to this registration, and calculation and charging of the fee. Moreover, information amount is calculated and charged for the road information utilizer 503 which requires detailed information.

As the system, a registration window is opened first (S601). Then, a use registration application from a user is awaited (S602). If the application is filed, it is confirmed whether or not the user is a registered user (S603). The processing after the confirmation is basically the same as the above-described one. In the case of a not-registered user, however, announcing the user registration is performed (S603A), and a registration form is displayed in order to prompt the user registration (S603B).

After that, route-registration contents are accepted from the user (S604, S604A). Then, it is judged whether or not the present date is earlier than a use date by the time-interval of certain constant days (S605). Then, in the case of a judgment “no”, announcing the ordinary use is performed. In the case of a judgment “yes”, the fee is calculated (S606), and the route-registration contents and the corresponding fee are confirmed for the user (S607). If the user gives an approval, the fee is dropped from the user's account (S608), and anticipation traffic information is updated, and preparation for offering the user this information is made. Otherwise, the anticipation traffic information may be offered at this time (S609). If the user gives no approval, some other route registration contents can be accepted. It is also allowable to regard this acceptance as a modification of the registration contents.

Meanwhile, if the user has used the in-advance registered route (S608A), it is confirmed whether or not the route used has coincided with the registered route (S610). Then, in the case of “no”, it is confirmed whether or not the cause therefor is a cause which should not be attributed to the blame for the user himself or herself, e.g., a traffic accident caused by someone else utterly unconcerned with the user (S611). Unless otherwise, it is determined that an additional difference-amount (S612) will not be charged. If a request for wishing and using the traffic information has been made, this information will be offered.

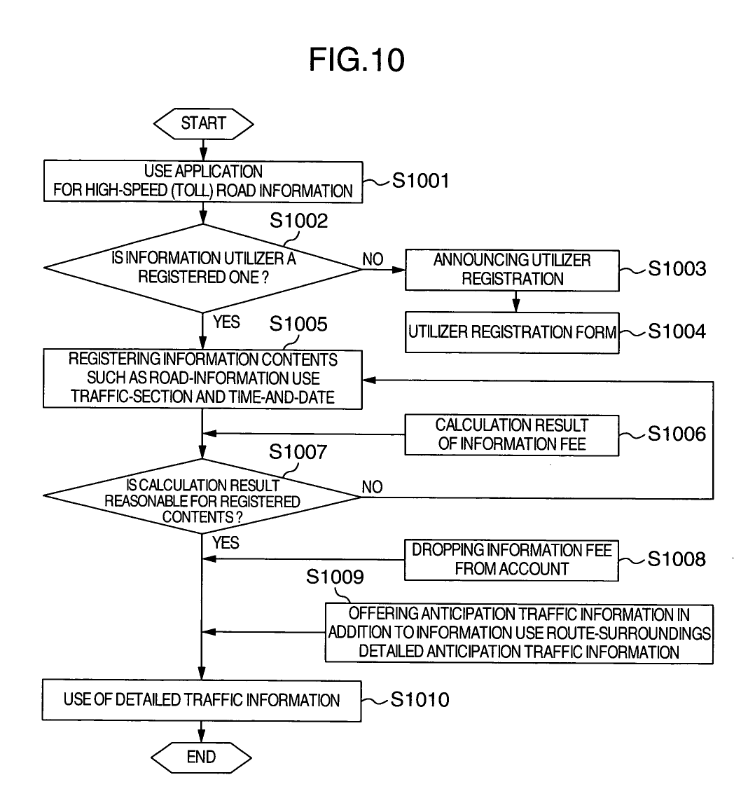

On the other hand, FIG. 10 illustrates a flow embodiment in the case where the road information utilizer 503 uses the system. Schematically speaking, similarly to the above-described embodiment, there exist the following steps: Namely, first, the user registration is made. Next, there exist the registration of a route or the like whose information is needed, the fee payment and the reception/utilization of information in response to this registration, and further, various business expansions based on detailed information.

In order to acquire necessary information, the road information utilizer 503 registers information represented by parameters such as a certain route, a certain traffic section, and a certain time. This registration allows the utilizer to acquire detailed traffic information such as certain specific road and time which are utilizable for a utilizer's own business or the like.

Hereinafter, the detailed explanation will be given below concerning this flow embodiment.

At a step S1001, the road information utilizer files a use application for high-speed (toll) road information. This use application is filed in order that the utilizer (such as transporter or travel agent) can acquire traffic-congestion information in specific parameters (e.g., traffic section and time) that the utilizer requires. At a step S1002, it is judged whether or not the information utilizer is a registered one. If the information utilizer has been not registered, announcing the utilizer registration is performed for prompting the utilizer registration (S1003), and displaying a utilizer registration form is performed (S1004). If, at the step S1002, it has been judged that the information utilizer is the registered one, at a step S1005, a registration is made concerning the road information for which the use application has been filed. After that, at a step S1006, fee for the registered road information is calculated. Moreover, at a step S1007, it is confirmed whether the calculation result is reasonable for the registered contents. Here, if the registration contents and the information fee should be modified, the processing goes back to S1005.

If the calculated information fee presents no problem as a result of the confirmation at S1007, the information fee is dropped from the utilizer's account (S1008). Then, the road information utilizer continues the use of the detailed traffic information (S1010) while receiving the offering of the information for which the use application has been filed (S1009). Here, examples of the information offered are anticipation traffic information in addition to information use route-surroundings detailed anticipation traffic information.

Namely, registering the information allows the information fee to be calculated in response thereto. Then, if the approval is given to the calculated information fee, the fee is dropped from the account, and the desired information is offered. Although the processing steps on the system basis are completed with the information offering, taking advantage of the offered information makes it possible to promote the business effectively.

Hereinafter, the detailed explanation will be given below concerning a part of each of the above-described steps.

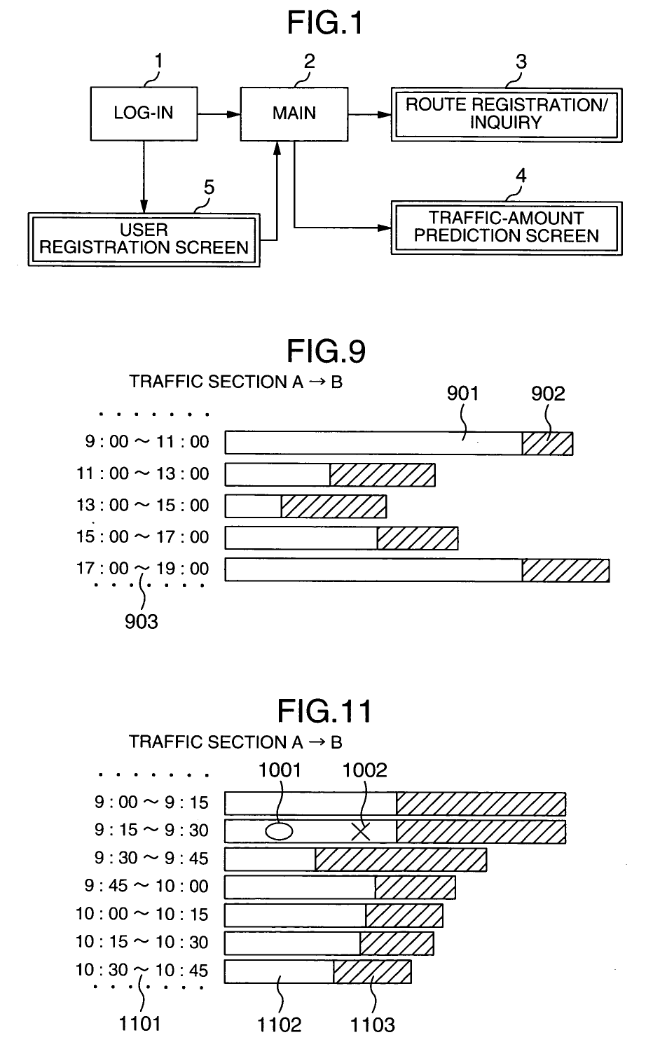

In accordance with a screen flow illustrated in FIG. 1, the explanation will be given below regarding the outline at the time when the user registers his or her own travel route. A person who will register the travel route, using the log-in ID and password, logs in to the system from a log-in screen via such a terminal device as a personal computer. If this is the first-time use for the person, the person makes user registration 5. Once the person has made the user registration, the person is capable of omitting various inputting items at the next or thereinafter uses. This allows the prevention of leakage of personal information due to an inputting mistake, and eventually, allows the prevention of spoofing by someone else. Service by an ETC (: electronic toll collection system) on the toll road is offered at present. The employment of this system in the present embodiment, further, makes the user feel at ease in the protection of the personal information. Also, the employment of a smart plate makes it possible to recognize the ID, thereby allowing the equal utilization of the present system without relying on the ETC. Also, in the case of, e.g., a common road, if a narrow-band communications antenna is installed in a gas station or signal device, merely setting the antenna on the vehicle side permits the implementation of basically the same service.

The screen used for inputting the user registration information may be a screen for inputting the information, examples of which are vehicle number, credit card number, and vehicle-mounted ETC equipment number. Here, the information which functions as the ID becomes necessary. Incidentally, if there exists information which is associated with the ID and is capable of being billed, it becomes possible to bill the information on the spot then and there. When the registration has been completed, the log-in ID and password are granted to the user. Of course, the registrant may also perform the setting. When the registration has been completed in this way, at least the ID and bill-capable information will be stored into a memory unit on the center side.

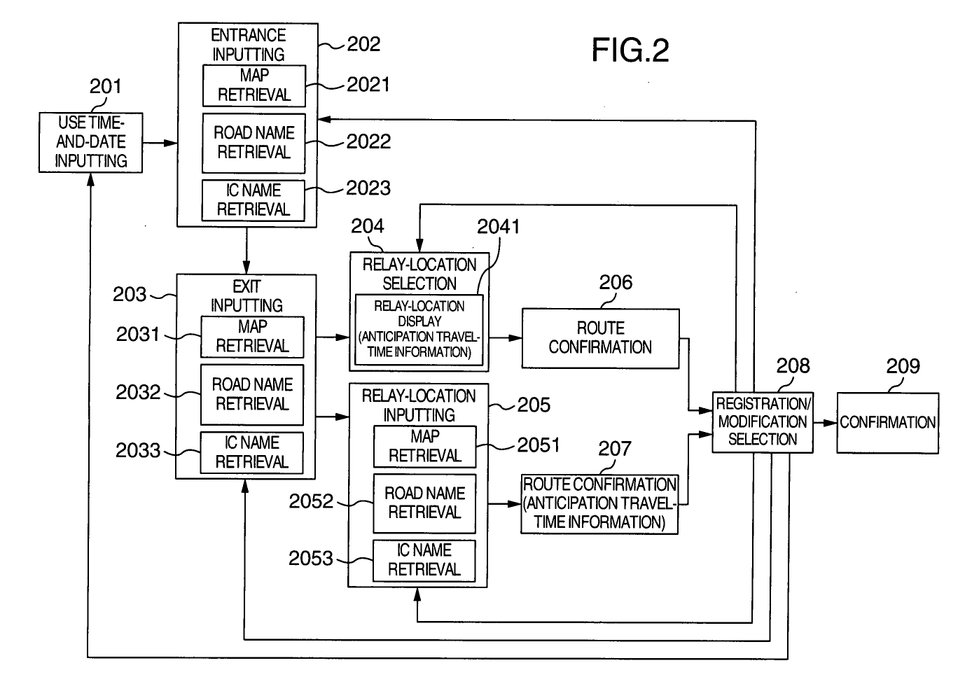

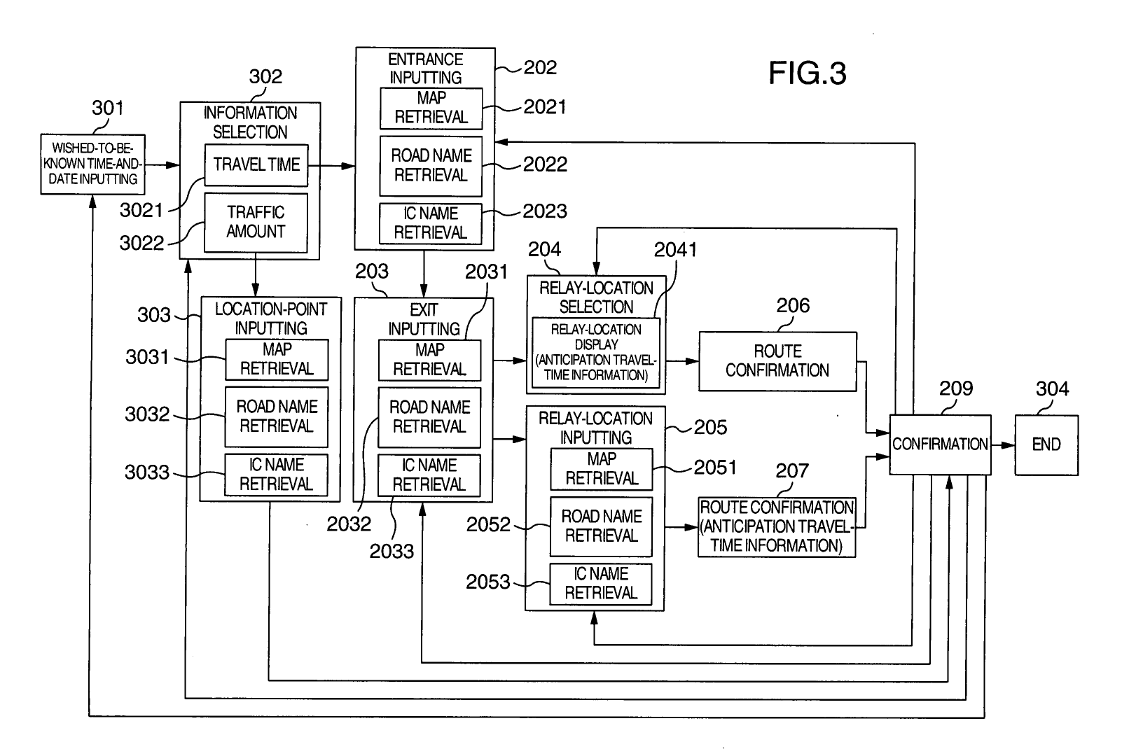

After completing the registration and logging in to the system in this way, the user, on a main screen 2, can make a selection between two alternatives, i.e., proceeding to registration of an individual route and a diving-route registration/inquiry screen 3, and proceeding to a traffic-amount prediction screen 4. However, since the information such as the log-in ID needed for the diving-route registration/inquiry and the information such as the log-in ID needed for the traffic-amount prediction are common to each other, the traffic-amount prediction screen 4 may be displayed simultaneously with the diving-route registration/inquiry screen 3. FIG. 2 and FIG. 3 illustrate screen flow details of the diving-route registration/inquiry screen 3 and screen flow details of the traffic-amount prediction screen 4, respectively. In FIG. 2 and FIG. 3, the same numbers are allocated to the same functions. The only differences therebetween are as follows: Wished-to-be-known time-and-date inputting 301, information selection 302, location-point inputting 303, and END 304 illustrated in FIG. 3.

As illustrated in FIG. 2 and FIG. 3, depending on the usage, it is required to specify use time-and-date 201, the traffic-information-wished-to-be-known time-and-date 301, and the places 202 to 205 (i.e., entrance/exit ICs (interchanges), relay-locations, and the like). In whatever case, the entrance IC 202 and the exit IC 203 are specified. In this case, relay-location selection is made at relay-location selection 204 displayed with an anticipation transit point-in-time. Otherwise, relay-location inputting 205 is performed to cause the anticipation transit point-in-time on the route to be displayed, thereby making route confirmation 206 or 207. Although not illustrated, in order to enhance convenience for the user, the following processings may also be performed: Namely, first, a high-speed road/toll road that the user wishes to use, or a relay-location such as SA (: service area), PA (: parking area), or place name is caused to be selected or inputted. Then, candidates for the entrance IC and candidates for the exit IC are respectively displayed, then being caused to be selected. After the entrance IC and the exit IC have been selected, the anticipation transit point-in-time at an appropriate relay-location such as the selected SA is displayed, thereby making the route confirmation.

After that, when making the registration of a diving route, registration 208 is made, and then confirmation 209 is performed. This diving route will be also stored into the memory unit. When this confirmation 209 has been performed, a bill processing unit bills the fee for the diving route to a credit card specified in advance. This is performed in order to enhance a probability that the registrant will drive along the diving route exactly as registered. Performing the bill processing to the credit card in advance permits the road enterpriser to ensure a certain extent of funds management time-period. Also, the in-advance billed fee becomes an original capital for the road fee reduction service, thereby making a contribution to assurance of the profitability. When seen from the user side, the credit card can be valid for the insurance in the case of an erroneous billing or the like. This makes it possible to make the user feel at ease. Also a large number of in-advance registered users can be anticipated on the basis of existence of the reduced fee.

On the other hand, if no merits are granted to the registrants, there appears no increase in the number of the registrants themselves. This makes it impossible to establish the information providing system as a system. Accordingly, services are carried out which reduce the toll-road fee based on the in-advance diving route registration, usage fee for facilities such as an amusement park, and usage fee for a cellular-phone or an on-boad unit. Even at this stage, it can be considered that there still exists a user who hesitates to make the in-advance registration. Consequently, differences are established in the reduction in such a manner that a 10% reduction in the toll-road fee is granted to an in-advance registrant, and a 5% reduction is granted to a person who has actually transited the route which is the same as the one specified in the in-advance registration. A person who has not selected the billing at the time of the in-advance registration is capable of receiving the reduction service only when the actual diving route has coincided with the in-advance registered route. A confirmation is performed as to whether or not the information stored in the memory unit, such as the ID and the diving route, match the actual information on the driving vehicle. After the confirmation, the bill processing is performed. As described earlier, confirming whether or not the actual information coincides with the in-advance registration requires the existence of the ID.

The execution of the above-described flows allows the registrants, i.e., the system users, to be ensured in large number.

At this time, with respect to the reduction service based on the in-advance registration, modification/cancellation of the registration contents is made executable as required. As a result, services such as returning an amount paid at the in-advance payment are offered. If, however, a lot of modifications/cancellations have been made for the contents once registered, reliability for the system will be damaged. Accordingly, the modification/cancellation is set as being a little disadvantageous to the registrants. This means that, e.g., in the case of the modification, the reduction rate is changed from 10% to 9%, or from 5% to 4%. In the case of the cancellation, the cancellation is made possible by a 2% amount of the scheduled fee by the time of one week before the scheduled date, a 10% amount by the time of one day threrebefore, and a 50% amount on the very scheduled date. When dealing with the case where the registrant has not driven exactly as was registered, no reduction is granted. Consequently, an excess or insufficient difference-amount is adjusted at the time of the actual driving.

Incidentally, in the case where an accident has occurred on the high-speed road or the like, it can be considered that the registrant could not drive exactly along the in-advance registered route. If the registrant could not drive exactly along the registered route because of the circumstances on the road side, adjustment of the difference amount or the like is individually dealt with in the responsibility of a road manager.

Also, in order to enhance the convenience, registration contract may also be made on a monthly basis. If the proportion at which the actual use on week days is the use exactly registered is equal to 80% or more, it is determined that the reduction service may be granted to the registrant. Otherwise, of all the days including Saturday and Sunday, the proportion may be set as being 50% or more.

The road enterpriser 502 reflects the above-described registration contents on the anticipation traffic information at proper times, thereby making it possible to grape a road use future-trend by the system use registrants. Also, while watching this future-trend, a person who will register the travel route can make the in-advance registration of the travel route, and also can perform modification of the registration contents. Predicting what extent of traffic amount exists at what point-in-time requires the schedule transit point-in-time at a certain location-point. Accordingly, it is preferable that the registration contents of the travel route include at least the travel route itself and schedule transit point-in-times at any one or more location-points of the entrance/exit ICs, the relay-locations, and the like. Here, the schedule transit point-in-time at the exit IC, i.e., the final location-point on the travel route, exhibits a large time variation depending on the immediate road situation, and thus the point-in-time at the exit IC is difficult to predict. Consequently, the schedule transit point-in-time at the entrance IC is more recommendable. Also, it can be considered that the schedule transit point-in-times at both of the entrance/exit ICs are caused to be inputted. This, however, irritates the driver or so, thereby resulting in a not-a-little possibility of inducing an accident due to reckless driving. Accordingly, instead of causing the schedule transit point-in-times at the two location-points to be inputted, it is more desirable to set, e.g., a width of before-and-after about 30 minutes to 1 hour to the schedule transit point-in-times. The schedule transit point-in-times will be also stored into the memory unit. If the driver has transited the route within the tolerance time, the fee is reduced. This reduction makes it possible to give the drive an incentive to keep the point-in-times. Even if the driver has exceeded the tolerance time, no penalty is imposed, and the bill processing is performed with the authorized fee as the limit. This is performed in order to ensure the in-advance registrations of the travel routes as many as possible. The bill processing unit performs all of the bill processings.

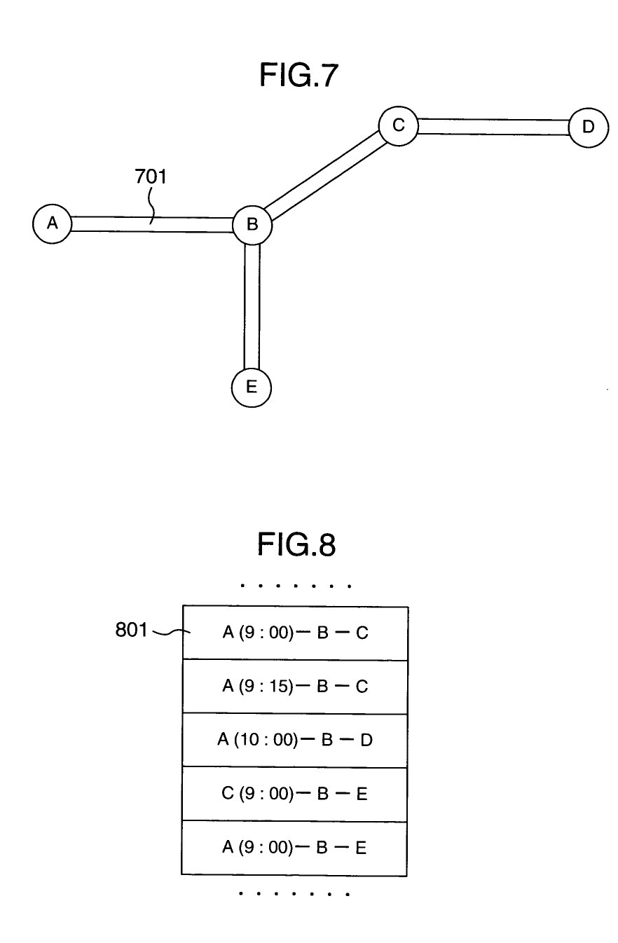

FIG. 7, FIG. 8, FIG. 9, and FIG. 11 illustrate the above-described contents concretely. FIG. 7 illustrates a tentative lane diagram 701 as an example. Vehicles scheduled to drive along the present lane make in-advance travel route registrations 801 as are illustrated in. FIG. 8. Here, five persons have made the registrations. For example, the uppermost-stage field indicates that the vehicle enters an entrance A at 9:00 and goes to C via B. The other-stage fields indicate basically the same situations. If a relay-location is unnecessary, the unnecessary relay-location can be omitted as is illustrated in the third-stage field. The road enterpriser 502 summarizes these registrations and then, as illustrated in FIG. 9, summarizes, e.g., “entrance anticipation transit situation at A in lane diagram 701” on each time basis 903 and on the basis of small-sized vehicles 901 and large-sized vehicles 902. Next, the road enterpriser 502 publicizes this summarized data as anticipation traffic information. FIG. 9 indicates that the traffic amount anticipated in the morning and evening is larger as compared with the one at the daytime, and that the proportion of the large-sized vehicles at the daytime is larger as compared with the one in the morning and evening.

As an example under the situation like this, as illustrated in FIG. 11, consider the case where, in a traffic section A-B, an unexpected sudden event 1002 such as an accident has occurred at about 9:30. Here, the contents of the in-advance travel route registrations as illustrated in FIG. 9 are analyzed in detail. Then, if, based on this analysis, it is proved that a result illustrated in FIG. 11 has appeared by modification/cancellation of the registrations, it becomes possible hereinafter to predict the future trend of the vehicles on 1001 which are driving toward the unexpected sudden event 1002. For example, it becomes possible to transmit and publicize the scale of a traffic congestion and the convergence prediction with the accuracy enhanced. Here, the scale of the traffic congestion and the convergence prediction are based on, as illustrated in FIG. 11, anticipation of a tendency for the driving vehicles to decrease with a gradual lapse of time 1101 after 9:30, the proportion of the large-sized vehicles 1103 and that of the small-sized vehicles 1102, the scale of the unexpected sudden event 1002, and the like.

In this way, as a utilization method for the traffic amount grasped from the registration contents, it is possible to perform convergence prediction or the like at the time when a traffic congestion has started because of an unexpected sudden accident or the like. Also, based on the traffic-concentration amount prediction, the user is capable of avoiding the traffic congestion. The road enterpriser carries out a reduction service for a deserted lane made apparent, thereby making it possible to adjust the transit fee. An example of this is an enhancement of the road use ratio resulting from the use of toll roads by the local-area residents. Mentioning further, it also becomes possible to implement averaging of the use ratio by adjusting the fee for each road in correspondence with the traffic amount predicted.

In order to establish this traffic-information providing service as one business mode further, it can be considered that further detailed traffic information is delivered and requested to be utilized for the enterprises of the road information utilizer 503 or the like. This is a business mode whose income source is the pay offering and delivery of area-limited fine-grained information based on the in-advance travel route registration information, i.e., the detailed traffic information. The road information utilizer or the like, which wishes to acquire and utilize for the enterprises not only the publicized information but also the further detailed traffic information, makes a payment for the information fee, thereby receiving the offering of the detailed traffic information. Of course, the detailed traffic information requires the anticipation and prediction of the traffic information to which not only the existence of the user who has made the in-advance registration but also the existence of the vehicles other than the user have been added.

The above-described traffic information is determined by an arithmetic-calculation unit in the center. The traffic information thus calculated will be stored into a memory unit so as to be offered to the road information utilizer or the like. It is preferable that this memory unit be logically or physically separated from the memory unit for storing the ID information and the like. Here, it can be considered that presentation of the anticipation traffic amount equivalent to the in-advance registration and the other types of anticipation traffic amount in a manner of being color-separated makes it easier to use the traffic information. This is because such color-separation leads to respective displays of traffic information by the fixed amount and traffic information by the varied amount. As methods for offering the traffic information, the information can be provided via telecommunications lines so that the information can be watched at home or office, or can be provided via wireless communications lines so that the information can be watched by the drivers instantly.

For example, the mode illustrated in FIG. 5 can be considered. Namely, in a store existing in the road surroundings area, the number of visiting customers is anticipated from the traffic amount, and the anticipated number is reflected on purchase quantity, then performing order adjustment. This allows the store to save the waste. Also, a party which constructs fee-office gates sets construction traffic-section properly, or adjusts in advance an increase/decrease in the number of the fee-office gates. This allows the party to save the waste. Also, a transporter which necessitates regular-time transportation avoids traffic congestion, or sets the most efficient route beforehand. This allows the transporter to make a vehicle-allocation arrangement without waste. Also, the use of the traffic amount on each time or each time-period basis makes it possible to adjust the purchase quantity of food materials. As having been explained so far, if there exists a party which will be able to enjoy profit or to reduce wasted cost by the delivery of the detailed traffic information rather than general traffic information, it becomes possible to offer the information to the party and to receive the price therefor. The method for paying the information fee may be either fixed-amount payment on a monthly basis or fee payment for each inquiry for the center.

Incidentally, in the present explanation, an assumption has been made that the exchange of the predetermined information be executed on the Internet via personal computers or the like. It is needless to say, however, that basically the same method for this exchange is also executable concerning mobile terminals such as cell phone and PDA (: Personal Digital Assistant), vehicle-mounted terminal, FAX, and the other appliances and equipments.

As having been explained so far, the traffic amount is predicted based on a travel route which the user has registered. This characteristic makes it possible to provide the fine-grained traffic information.

It should be further understood by those skilled in the art that although the foregoing description has been made on embodiments of the invention, the invention is not limited thereto and various changes and modifications may be made without departing from the spirit of the invention and the scope of the appended claims.

1. A traffic-information providing method, comprising the steps of:
accepting registration from an on-board unit to a center concerning ID information for identifying a vehicle, billing information associated with said ID information, and information about a travel route along which said vehicle is scheduled to drive and which includes a toll road,
calculating, at said center, future traffic information based on said travel route registered into said center, and
providing said calculated future traffic information via a communications line.

2. The traffic-information providing method according to claim 1, wherein
said center accepts registration of a passage time on said travel route,
said center calculating said future traffic information on each predetermined-time basis.

3. The traffic-information providing method according to claim 1, further comprising a step of billing a reduced fee for said toll road to said billing information when said registration has been accepted.

4. The traffic-information providing method according to claim 1, further comprising a step of billing a reduced fee for said toll road to said billing information if said vehicle, which had made said registration, has driven exactly along said travel route.

5. The traffic-information providing method according to claim 1, wherein
said center accepts, from said vehicle, registration of the passage time on said travel route,
said traffic-information providing method further comprising a step of billing an authorized fee for said toll road to said billing information if said vehicle, which had made said registration, has driven exactly along said travel route in such a manner that said vehicle has exceeded a predetermined tolerance time from said passage time.

6. A traffic-information providing system, comprising:
a first memory area for accepting registration from a terminal to a center concerning ID information for identifying a vehicle type, toll payment information associated with said ID information, and information about a travel route along which said vehicle is scheduled to drive and which includes a toll road, and for storing these pieces of information,
a calculation area for determining, at said center, future traffic information based on said travel route registered into said center, and
a second memory area for storing said determined future traffic information, wherein
said future traffic information stored in said second storage unit is provided via a communications line.

7. The traffic-information providing system according to claim 6, wherein
said center accepts registration of a passage time on said travel route, and stores said passage time into said first memory area,
said calculation area calculating said future traffic information on each predetermined-time basis.

8. The traffic-information providing system according to claim 6, further comprising a bill processing unit for billing a reduced fee for said toll road to said toll payment information when said registration has been accepted.

9. The traffic-information providing system according to claim 6, further comprising a bill processing unit for billing a reduced fee for said toll road to said toll payment information if said vehicle, which had made said registration, has driven exactly along said travel route.

10. The traffic-information providing system according to claim 6, wherein
said center accepts registration of a passage time on said travel route, and stores said passage time into said first storage unit,
said traffic-information providing system further comprising a bill processing unit for billing an authorized fee for said toll road to said toll payment information if said vehicle, which had made said registration, has driven exactly along said travel route in such a manner that said vehicle has exceeded a predetermined tolerance time from said passage time.

11. A toll-road fee payment method, comprising the steps of:
registering, from an on-board unit to a center, ID information for identifying a host vehicle, and information about a travel route along which said host vehicle is scheduled to drive and which includes a toll road, said host vehicle mounting thereon a vehicle-mounted ETC equipment into/from which an IC card is to be inserted/extracted, and
settling a reduced fee for said toll road with the use of said IC card if said host vehicle has driven exactly along said travel route registered, said IC card being inserted into said vehicle-mounted ETC equipment.

12. The toll-road fee payment method according to claim 11, further comprising the steps of:
registering a passage time on said travel route into said center, and
settling an authorized fee for said toll road with the use of said IC card if said host vehicle has driven exactly along said travel route in such a manner that said host vehicle has exceeded a predetermined tolerance time from said passage time.

13. The toll-road fee payment method according to claim 11, wherein said host vehicle includes a vehicle-mounted terminal device,
said toll-road fee payment method further comprising a step of providing traffic information to said vehicle-mounted terminal device via a communications line if said traffic information has been requested from said vehicle-mounted terminal device to said center, said traffic information being calculated at said center.

14. A traffic-information providing method, comprising the steps of:
accepting registration from a terminal to a center concerning ID information for identifying a vehicle, toll payment information associated with said ID information, and information about a travel route along which said vehicle is scheduled to drive and which includes a toll road,
predicting and calculating, at said center, future traffic information based on said travel route registered into said center,
providing said predicted traffic information to said vehicle via a communications line,
judging whether or not said vehicle is driving in accordance with said predicted traffic information, and
making a fee payment in accordance with both of said judgment result and said tall payment information.
